(19) United States
(12) Patent Application Publication
(10) Pub. No.: US 2021/0380237 A1
(43) Pub. Date: Dec. 9, 2021

(54) NAVIGATION CONTROL SYSTEM FOR STATIONARY OBSTACLE AVOIDANCE

(71) Applicant: Everseen Limited, Blackpool (IE)

(72) Inventors: Alan O'Herlihy, Glenville (IE); Mark Ibbotson, Bentonville, AR (US); Bogdan Ciubotaru, Donoughmore, Cork (IE); Dan Alexandru Pescaru, Timisoara (RO); Ciprian David, Timisoara (RO); Cosmin Cernazanu-Glavan, Timisoara (RO); Vasile Gui, Timisoara (RO)

(21) Appl. No.: 17/336,486

(22) Filed: Jun. 2, 2021

Related U.S. Application Data
(60) Provisional application No. 63/043,816, filed on Jun. 25, 2020.
(60) Provisional application No. 63/034,155, filed on Jun. 3, 2020.
(60) Provisional application No. 63/034,165, filed on Jun. 3, 2020.

(51) Int. Cl. B64C 39/02; G06K 9/46; G06K 9/00; G06T 3/00; G06T 7/155; G06T 7/579; G05D 1/10

(52) U.S. Cl. CPC B64C 39/024; G06K 9/4604; G06K 9/0063; G06T 3/0087; B64C 2201/141; G06T 7/579; G05D 1/1064; G06T 2207/10032; G06T 2207/10028; G06T 7/155

(57) ABSTRACT

A navigation control system for an aerial robotic device suspended from a carrier device in an aerial movement volume of an aerial module. The navigation control system is configured to detect one or more stationary obstacles located in corresponding Aerial Movement Volume, create a 3D map representing the Aerial Movement Volume together with one or more bounding boxes enclosing each stationary obstacle in the Aerial Movement Volume, use an optimisation algorithm to compute an optimal route for the aerial robotic device, determine control parameters for a plurality of electric stepper motors driving the carrier device and the aerial robotic device based on the computed optimal route for the aerial robotic device, and navigate the aerial robotic device in accordance with the computed optimal route to enable the aerial robotic device to reach the required destination while avoiding intervening stationary obstacles.

### CROSS-REFERENCE TO RELATED APPLICATION(S)

This application claims priority to and the benefit of U.S. Provisional Application Ser. No. 63/034,155, filed Jun. 3, 2020, U.S. Provisional Application Ser. No. 63/034,165, filed Jun. 3, 2020, and U.S. Provisional Application Ser. No. 63/043,816, filed Jun. 25, 2020, the entire disclosures of which are hereby incorporated by reference.

### TECHNICAL FIELD

The present disclosure relates generally to a navigation control system for stationary obstacle avoidance. More particularly to a system and method for navigating an aerial robotic device in the presence of static, or stationary, obstacles within a bounded movement volume.

### BACKGROUND

An unmanned, or uncrewed, aerial vehicle (UAV) commonly known as a drone is an aircraft without a human pilot on board. UAVs are a component of an unmanned aircraft system (UAS), which include the UAV itself, a ground-based controller, and a communication system for facilitating bi-directional communication between the UAV and the ground-based controller. The flight of UAVs may operate with various degrees of autonomy, either under remote control by a human operator or autonomously using onboard sensors and controllers.

Traditional wired aerial robotic devices require manual control of their movements by a trained operator using a joystick apparatus. However, such manual control is an overly labour-intensive process and requires significant motor skills on the part of the human operator.

### SUMMARY

In one aspect of the present disclosure, there is provided an aerial navigation system. The aerial navigation system comprises an aerial robotic device suspended from a vertical wire connected to a carrier device. The carrier device is connected to a plurality of anchor points mounted on corresponding plurality of upright members at a substantially same height from a ground through a set of horizontal wires in a bounded horizontal plane mutually subtended by the plurality of anchor points. The aerial robotic device is moveable within an aerial movement volume defined between the ground, the plurality of upright members and the horizontal plane. The aerial navigation system further comprises a navigation control system for navigating the aerial robotic device in the Aerial Movement Volume. The navigation control system is configured to detect one or more stationary obstacles located in the Aerial Movement Volume, create a 3D map representing the Aerial Movement Volume together with one or more bounding boxes enclosing each stationary obstacle in the Aerial Movement Volume, compute an optimal route for the aerial robotic device from a start location to a destination location so as to avoid an intervening stationary obstacle, determine control parameters for a plurality of electric stepper motors driving the carrier device and the aerial robotic device based on the computed optimal route for the aerial robotic device, and navigate the aerial robotic device in accordance with the computed optimal route to enable the aerial robotic device to reach the destination location while avoiding intervening stationary obstacles.

In another aspect of the present disclosure, there is provided a method for navigating the aerial robotic device. The method comprises detecting one or more stationary obstacles located in the Aerial Movement Volume, creating a 3D map representing the Aerial Movement Volume together with one or more bounding boxes enclosing each stationary obstacle in the Aerial Movement Volume, computing an optimal route for the aerial robotic device from a start location to a destination location so as to avoid an intervening stationary obstacle, determining control parameters for a plurality of electric stepper motors driving the carrier device and the aerial robotic device respectively, based on the computed optimal route for the aerial robotic device, and navigating the aerial robotic device in accordance with the computed optimal route to enable the aerial robotic device to reach the destination location while avoiding intervening stationary obstacles.

In yet another aspect of the present disclosure, embodiments disclosed herein are also directed to a non-transitory computer readable medium having stored thereon computer-executable instructions which, when executed by a processor, causes the processor to perform the steps of the method disclosed herein.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

FIG. 1 illustrates aerial navigation system having an aerial module and an aerial robotic device therein, in accordance with an embodiment of the present disclosure;

FIG. 2 illustrates a carrier device referential system (CDRS) formed in the horizontal plane of the aerial module, in accordance with an embodiment of the present disclosure;

FIG. 3 illustrates expansion of the CDRS into a 3D navigation reference system (3DNRS) used for navigation, in accordance with an embodiment of the present disclosure;

FIG. 4 illustrates a method for navigating the aerial robotic device within an aerial movement volume of the aerial module, in accordance with an embodiment of the present disclosure;

FIG. 5 illustrates the steps of an Initialisation Phase of the method of FIG. 4, in accordance with an embodiment of the present disclosure;

FIG. 6 illustrates an example of a movement schema to be executed by the carrier device during the Initialisation Phase of FIG. 5 in accordance with an embodiment of the present disclosure;

FIG. 7 illustrates a cuboid representing a bounding box, in accordance with an embodiment of the present disclosure;

FIG. 8 illustrates the steps of a Navigation Path Creation Phase of the method of FIG. 4, in accordance with an embodiment of the present disclosure;

FIG. 9 illustrates an example of a Search Plane Collision Map, in accordance with an embodiment of the present disclosure;

FIG. 10 illustrates a uniform 2D grid created from the Search Plane Collision Map, in accordance with an embodiment of the present disclosure;

FIG. 11 illustrates the steps of a calculate Optimal Route Polyline step of the Navigation Path Creation Phase of FIG. 8, in accordance with an embodiment of the present disclosure; and

FIG. 12 illustrates an Optimal Route Polyline in a Search Plane or a corresponding Search Plane Collision Map of FIG. 9, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF ILLUSTRATIVE EMBODIMENTS

The following detailed description illustrates embodiments of the present disclosure and ways in which they can be implemented. Although the best mode of carrying out the present disclosure has been disclosed, those skilled in the art would recognize that other embodiments for carrying out or practicing the present disclosure are also possible.

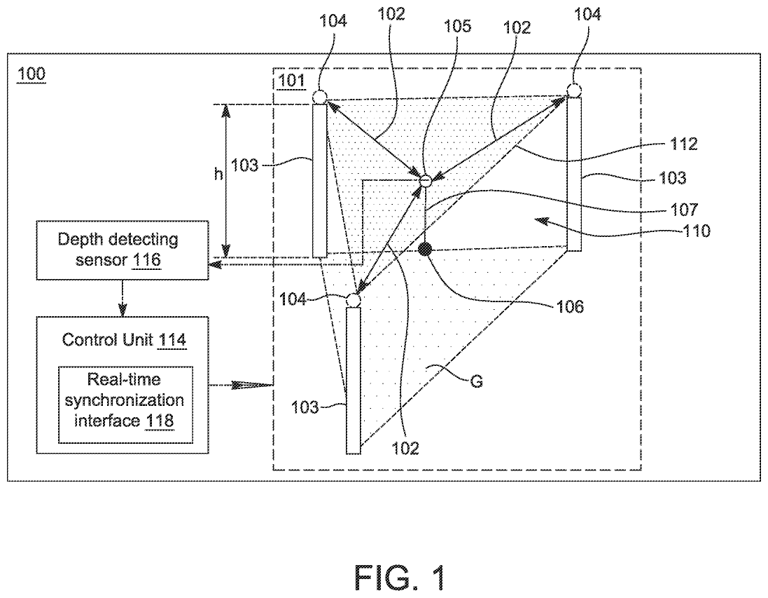

FIG. 1 illustrates an aerial navigation system 100 in accordance with an embodiment of the present disclosure. The aerial navigation system 100 includes an aerial module 101 having a plurality of upright members 103, each of which is supported on a ground surface G (hereinafter referred to as ‘the ground’ and denoted using identical reference ‘G’). To accomplish adequate support, the upright members 103 may, at least partly, be driven into the ground G. Examples of structures that can be used to form the upright member 103 may include, but is not limited to, a wall, a pillar, a pole, or a post. An elevated anchor point 104 is mounted on each upright member 103 at a substantially same height as from the ground G. Each elevated anchor point 104 is provided with an electric motor (not shown) which includes a rotor (not shown). In an example, each of these electric motors may be implemented by use of a direct current (DC) stepper motor.

A carrier device 105 is coupled to the electric motors at corresponding ones of the anchor points 104 using a set of wires 102 (hereinafter individually referred to as ‘the horizontal wire’ and denoted using identical reference numeral ‘102’). That is, the rotor from each electric motor is coupled with a first end of a corresponding horizontal wire 102 that is arranged so that the rest of the corresponding horizontal wire 102 is at least partly wrapped around the rotor. Moreover, a second end of each horizontal wire 102 from the set of horizontal wires 102 is coupled with the carrier device 105. The carrier device 105 itself houses at least one electric motor (not shown), each of which includes a rotor (not shown). In an example, each of the electric motors associated with the carrier device 105 may be implemented by use of a direct current (DC) stepper motor. The rotor of the carrier device 105 is coupled with a first end of a wire 107 (hereinafter referred to as ‘the vertical wire’ and denoted using identical reference numeral ‘107’). The vertical wire 107 is arranged so that the rest of the vertical wire 107 is at least partly wrapped around the rotor of the carrier device 105. A robotic device 106 is suspended from a second end of the vertical wire 107. Thus, the set of horizontal wires 102, the ground G, the plurality of upright members 103 collectively define a volume within which the robotic device 106 resides. For clarity, this volume will be referred to henceforth as the Aerial Movement Volume 110.

The carrier device 105 is adapted to operably move within the bounded horizontal plane 112 defined between the elevated anchor points 104. This movement is achieved through the activation of the electric motors in the anchor points 104 to cause the horizontal wire 102 coupled to each electric motor to be further wound or unwound from the electric motor's rotor, thereby shortening or lengthening each such horizontal wire 102. The robotic device 106 is adapted to move vertically relative to the carrier device 105 through the activation of the electric motor(s) in the carrier device 105 to cause the vertical wire 107 coupled to each electric motor of the carrier device 105 to be further wound or unwound from the electric motor's rotor, thereby shortening or lengthening the vertical wire 107.

A depth-detecting sensor 116 is mounted on the carrier device 105 in a downwards facing orientation. In one embodiment, the depth-detecting sensor 116 may include an RGB-D sensor that combines RGB colour information with per-pixel depth information. In another embodiment, the depth-detecting sensor 116 may include a radar sensor. The skilled person will understand that the above-mentioned examples of depth-detecting sensors are provided for illustration purposes only. In particular, the skilled person will understand that the preferred embodiment is not limited to the use of these above-mentioned depth-detecting sensors. Instead, the preferred embodiment is operable with any sensor capable of detecting the distance between itself and another object detected within the range of the sensor.

When the Aerial Movement Volume 110 is defined by the relative arrangement of the horizontal wires 102, upright members 103 and the ground G, the location of the robotic device 106 within the Aerial Movement Volume 110 is defined by the following parameters:
(a) the coordinates of the carrier device 105 in the bounded horizontal plane 112 defined by the elevated anchor points 104; and
(b) the distance between the carrier device 105 and the robotic device 106, the said distance representing the vertical penetration of the robotic device 106 into the Aerial Movement Volume 110.

The co-ordinates of the carrier device 105 in the horizontal plane 112 is determined by the lengths of the individual horizontal wires 102 coupling the carrier device 105 to each of the respective elevated anchor points 104. Similarly, the distance between the carrier device 105 and the robotic device 106 is denoted by the unwound length of the vertical wire 107 connecting the robotic device 106 to the carrier device 105.

The carrier device 105 is adapted to move within the bounded horizontal plane 112. This movement is achieved through the activation of the electric motors in the anchor points 104 to cause the horizontal wire 102 coupled to each electric motor to be further wound or unwound from the electric motor's rotor, thereby shortening or lengthening each such horizontal wire 102. The robotic device 106 is adapted to move vertically relative to the carrier device 105 through the activation of the electric motor(s) in the carrier device 105 to cause the vertical wire 107 coupled to each electric motor to be further wound or unwound from the electric motor's rotor, thereby shortening or lengthening the vertical wire 107. In view of the above, for brevity, the electric motors in the anchor points 104 will be referred to henceforth as Horizontal Movement Motors. Similarly, the electric motor(s) in the carrier device 105 will be referred to henceforth as Vertical Movement Motor(s).

In an embodiment of the present disclosure, the aerial module 101 is controlled by a navigation control system 114 (hereinafter referred to as ‘the control unit’ and denoted using identical reference numeral ‘114’). The control unit 114 may be implemented as one or more microprocessors, microcomputers, microcontrollers, digital signal processors, logic circuitries, and/or any devices that manipulate data based on one or more instructional codes. The control unit 114 may be implemented as a combination of hardware and software, for example, programmable instructions that are consistent with the implementation of one or more functionalities disclosed herein.

In an embodiment of the present disclosure, the control unit 114 may be configured to determine a location of the robotic device 106 within the Aerial Movement Volume 110. The control unit 114 is further configured to synchronise the operations of the Horizontal Movement Motors and the Vertical Movement Motors to permit the robotic device 106 to be moved from its current location to a target location within the Aerial Movement Volume 110, without the necessity of human intervention. In an embodiment of the present disclosure, the control unit 114 includes a navigation system configured to calculate a route between the current and target locations of the robotic device 106.

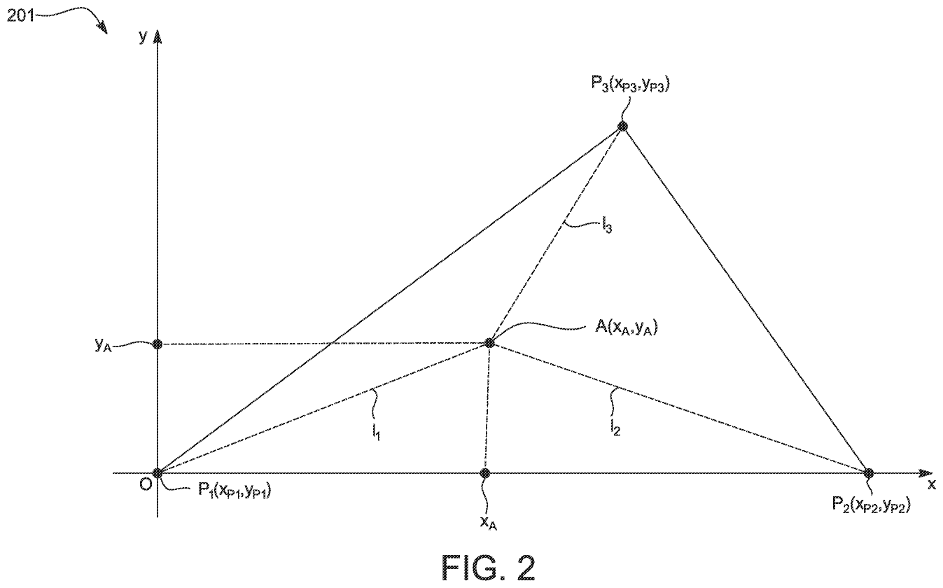

FIG. 2 illustrates a carrier device referential system (CDRS) 201 formed in the horizontal plane 112 defined by the three Horizontal Movement Motors.

With combined reference to FIGS. 1 and 2, in an embodiment, the CDRS 201 is a triangular 2D projection of the Aerial Movement Volume 110 onto the horizontal plane 112. As such, in an embodiment as best shown in the view of FIG. 1, the Aerial Movement Volume 110 defined between the upright members 103, the ground G and the horizontal plane 112 is a prismatic volume. The CDRS 201 comprises three vertices P1, P2 and P3, wherein the first vertex P1 corresponds to the intersection of the horizontal plane 112 with a first one of the upright members 103, the second vertex P2 corresponds to the intersection of the horizontal plane 112 with a second one of the upright members 103, and the third vertex P3 corresponds to the intersection of the horizontal plane 112 with a third one of the upright members 103.

Within the CDRS 201, the position of each of P1, P2 and P3 is denoted by (x_{P1}, y_{P1}), (x_{P2}, y_{P2}) and (x_{P3}, y_{P3}) respectively. The first vertex P1 is defined to be the origin of the CDRS 201. Thus, x_{P1}=0 and y_{P1}=0. From this, it can also be inferred that y_{P2}=0. The remaining co-ordinates of the second and third vertices P2 and P3 are computed based on the known distances {d_{P1P2}, d_{P1P3}, d_{P2P3}} between the upright members 103. More specifically, the co-ordinates of the three vertices P1, P2 and P3 are as follows:

$$\begin{matrix}{x}_{P 1} = 0 , {y}_{P 1} = 0 & ( 1 ) \\ {x}_{P 2} = {d}_{P 1 P 2} , {y}_{P 2} = 0 & ( 2 ) \\ {x}_{{p}_{3}} = \frac{{d}_{P 1 P 3}^{2} + {d}_{P 1 P 2}^{2} - {d}_{P 2 P 3}^{2}}{2 {d}_{P 1 P 2}} , {y}_{{P}_{3}} = \sqrt{{d}_{P 1 P 3}^{2} - {x}_{P 3}^{2}} & ( 3 )\end{matrix}$$

Referring to the CDRS 201 shown in FIG. 2, a current location of the robotic device 106 within the Aerial Movement Volume 110 corresponds to a start point A of the trajectory of the carrier device 105 in the horizontal plane 112. The start point A is connected to the vertices P1, P2 and P3 by line segments of length l₁, l₂ and l₃ respectively, where these lengths of these line segments correspond with the lengths of the horizontal wires 102 connecting the carrier device 105 to the elevated anchor points 104.

From the above formulation for the CDRS 201, the lengths (l_{1A}, l_{2A} and l_{3A}) of the line segments connecting the start point A of the carrier device 105 to the vertices P1, P2 and P3 can be expressed as follows:

l_{1A}=\sqrt{x_{A}²+y_{A}²} (4)

l_{2A}=\sqrt{(x_{P2}−x_{A})²+y_{A}²} (5)

l_{3A}=\sqrt{(x_{A}−x_{P3})²+(y_{P3}−y_{A})²} (6)

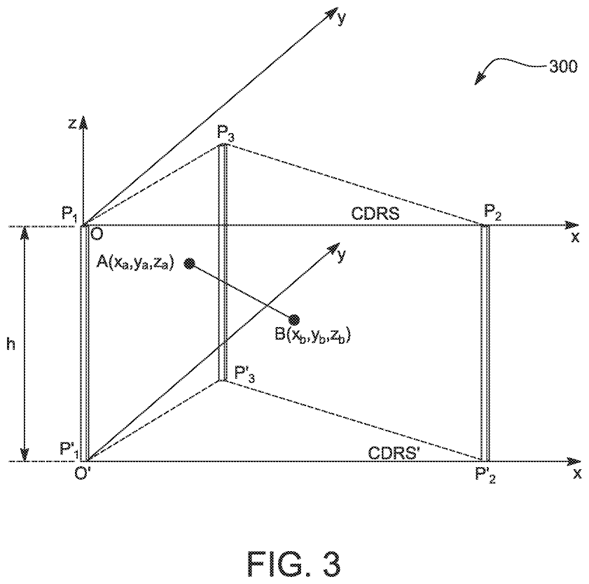

By considering the elevation of the Horizontal Movement Motors, the CDRS 201 may be expanded into a 3D navigation reference system (3DNRS) 300 as explained with reference to FIG. 3.

With combined reference to FIGS. 1 and 3, a first of the upright members 103 comprises a base point P′1 located level with the ground G. A first Horizontal Movement Motor (not shown) is mounted on the first upright member 103 at location P1 which corresponds with the location of the elevated anchor point 104 on the first upright member 103. The distance between P1′ and P1 is denoted by d_{P′1P1}. A second of the upright members 103 comprises a base point P′2 located level with the ground G. A second Horizontal Movement Motor (not shown) is mounted on the second upright member 103 at location P2 which corresponds with the location of the elevated anchor point 104 on the second upright member 103. The distance between P2′ and P2 is denoted by d_{P′2P2}. A third of the upright members 103 comprises a base P3′ located level with the ground G. A third Horizontal Movement Motor (not shown) is mounted on the third upright member 103 at location P3 which corresponds with the location of the elevated anchor point 104 on the third upright member 103. The distance between P3′ and P3 is denoted by d_{P′3P3}. In other words, d_{P′1P1}, d_{P′2P2} and d_{P′3P3} are the elevations of the first, second and third Horizontal Movement Motors respectively. Furthermore, because each of the first, second and third Horizontal Movement Motors is mounted on a respective first, second and third upright member 103 at the same height h above the ground, d_{P′1P1}=d_{P′2P2}=d_{P′3P3}=h.

In an embodiment of the present disclosure, a first horizontal plane CDRS' is the plane defined by the vertices P′1, P′2 and P′3, whereas a second horizontal plane CDRS is the plane defined by the vertices P1, P2 and P3. In other words, the second horizontal plane CDRS of FIG. 3 corresponds to the bounded horizontal plane 112 of FIG. 1. The second horizontal plane CDRS is disposed in parallel with the first horizontal plane CDRS′. Furthermore, the projection of the CDRS vertex P1 onto the CDRS' plane, is the vertex P′1 of the CDRS' plane. Thus, it is may be readily inferred that the 2D projection of any 3D point located inside the volume defined by P1, P2, P3, P′1, P′2, P′3 (i.e. Aerial Movement Volume 110 in FIG. 1) would have the same x and y coordinates in both the CDRS and CDRS' planes.

Using this construction, defining P′1 as the origin of the 3DNRS, and knowing the distances {d_{P1P2}, d_{P1P3}, d_{P2P3}} between each of the first, second and third Horizontal Movement Motors and the ground G, the x and y co-ordinates of the vertices P′1, P′2 and P′3 of the 3DNRS are defined as follows:

$$\begin{matrix}{x}_{{P}^{′} 1} = 0 , {y}_{{P}^{′} 1} = 0 , {z}_{{P}^{′} 1} = 0 & ( 7 ) \\ {x}_{{P}^{′} 2} = {d}_{{P}^{′} 1 {P}^{′} 2} , {y}_{{P}^{′} 2} = 0 , {z}_{{P}^{′} 2} = 0 & ( 8 ) \\ {x}_{{p}^{′} 3} = \frac{{d}_{{P}^{′} 1 {P}^{′} 3}^{2} + {d}_{{P}^{′} 1 {P}^{′} 2}^{2} - {d}_{{P}^{′} 2 {P}^{′} 3}^{2}}{2 {d}_{{P}^{′} 1 {P}^{′} 2}} , \\ {y}_{{{P}^{′}}_{3}} = \sqrt{{d}_{{P}^{′} 1 {P}^{′} 3}^{2} - {x}_{{P}^{′} 3}^{2}} , {z}_{{P}^{′} 3} = 0 , & ( 9 )\end{matrix}$$

The x and y co-ordinates of the vertices P′1, P′2 and P′3 of the 3DNRS are the same as those of the P1, P2 and P3 vertices. Indeed, the P′1, P′2 and P′3 vertices differ from the P1, P2 and P3 vertices in the z coordinate only (z_{P1}=z_{P2}=z_{P3}=d_{P′1P1}). Similarly, the distances between corresponding vertices in the first horizontal plane CDRS' is the same as those in the second horizontal plane CDRS. For example, d_{P1P2}=d_{P′1P′2}.

The z co-ordinate of the start point A represents the elevation from the ground of the robotic device 106 at the start point A. Since the carrier device 105, from which the robotic device 106 is suspended, is adapted to move within the bounded horizontal plane 112, the length l_{4A} of the line segment connecting the start point A to the second horizontal plane CDRS is given by

l_{4A}=h−z_{A} (10)

This length l_{4A} is equivalent to the length of the vertical wire 107 needed to bring the robotic device 106 to the elevation represented by the z co-ordinates of the start point A.

The target location of the robotic device 106 within the Aerial Movement Volume 110 corresponds to an end point B. In an analogous manner to the above derivation of the co-ordinates of the start point A, the co-ordinates of the end point B can also be defined in terms of the lengths of the horizontal wires l_{1B}, l_{2B} and l_{3B} and the length of the vertical wire l_{4B} that would be needed to respectively position the carrier device 105 and the robotic device 106 at the end point B corresponding to the target location of the robotic device 106.

In other words, using the above formulation for the CDRS, l_{1B}, l_{2B} and l_{3B} are the lengths of the line segments connecting the end point B to the vertices P1, P2 and P3 of the CDRS. In a similar manner to the equations (4), (5) and (6) for the start point A, the lengths l_{1B}, l_{2B} and l_{3B} are given by:

l_{1B}=\sqrt{x_{B}²+y_{B}²} (11)

l_{2B}=\sqrt{(x_{P′}_{₂}−x_{B})²+y_{B}²} (12)

l_{3B}=(x_{B}=x_{P′}_{₃})²+(y_{P′}_{₃}−y_{B})² (13)

Similarly, the length l_{4B} is given by:

l_{4B}=h−z_{B} (14)

A movement trajectory of the robotic device 106 from the current location to the target location in the Aerial Movement Volume 110 is denoted by the line segment connecting start point A to end point B in FIG. 3. To compute the time tₙₐᵥ taken by the robotic device 106 to travel from start point A to end point B, we consider a predefined speed m/s (e.g. ξ=0.1 m/s) for the carrier device 105:

$${t}_{n a v} = \frac{\sqrt{{( {x}_{A} - {x}_{B} )}^{2} + {( {y}_{A} - {y}_{B} )}^{2} + {( {z}_{A} - {z}_{B} )}^{2}}}{ξ} \qquad ( 15 )$$

Referring back to FIG. 1, to move the carrier device 105 from the start point A to the end point B, the aerial module 101 may include a local computing device (not shown) for faciliting bi-directional communication between the control unit 114 and the Horizontal Movement Motors; and for faciliting bi-directional communication between the control unit 114 and the Vertical Movement Motor(s). For instance, each Horizontal Movement Motor may be provided with a local computing device that controls its operation. Similarly, the or each Vertical Movement Motor may be provided with a local computing device that controls its operation. Each of the local computing devices may be implemented with a real-time operating system and low-level device drivers to control corresponding ones of the Horizontal Movement Motors and the Vertical Movement Motor(s).

In an embodiment of the present disclosure, the control unit 114 is configured to implement a navigation algorithm to compute parameters for each of the Horizontal Movement Motors and the Vertical Movement Motor(s) to cause movement of the carrier device 105 along the route, or trajectory, from the start point A to the end point B in the CDRS as shown in the views of FIGS. 2 and 3 respectively. These parameters are specific for each Horizontal Movement Motors i, i∈{1,2,3} and represent:
Number of rotation steps (nrotᵢ) needed for Horizontal Movement Motor hm (hm=1 to 3) to wind/unwind its horizontal wire 102 by a required length (where the Horizontal Movement Motor acts as a spool with its axel arranged so that it winds/unwinds q cm of horizontal wire 102 (e.g. q=0.01 m) with each complete rotation).

$$n r o {t}_{h m} = \frac{\vert {l}_{h m A} - {l}_{h m B} \vert}{q} \qquad ( 16 )$$

Direction of rotation (dirₕₘ): It is hereby envisioned that, in use, a Horizontal Movement Motor i winds or unwinds its corresponding horizontal wire 102 by the length (l_{hmA}) needed to move the carrier device 105 from the x and y co-ordinates of the start point A to the x and y co-ordinates of the end point B as detailed above. The rotation direction needed for such winding/unwinding operation is described as +1 for clockwise rotation and −1 for anticlockwise rotation. Therefore, dirₕₘ is computed using the following equation:

dirᵢ=sign(l_{hmA}−l_{hmB}) (17)
Speed of rotation θᵢ: It is hereby further envisioned that in order to move the carrier device 105 from the x and y co-ordinates of the start point A to the x and y co-ordinates of the end point B within a certain amount of time, all the Horizontal Movement Motors must wind/unwind their respective lengths of wire within the same amount of time. Thus, each Horizontal Movement Motor must be capable of operating at different speeds from the others. More specifically, to move the carrier device 105 at a predefined speed of ξ m/s (e.g. ξ=0.1 m/s), the rotational speed θₕₘ of each Horizontal Movement Motor (expressed as the number of rotations performed per second) is given by the following equation:

$${θ}_{h m} = \frac{n r o {t}_{h m}}{{t}_{n a v}} \qquad ( 18 )$$

Each local computing device may be provided with a buffer. Using the above equations, the control unit 114 may calculate the control parameters (nrotₕₘ, dirₕₘ and Ohm) for each Horizontal Movement Motor and communicate the control parameters for a given Horizontal Movement Motor to the local computing device associated therewith. The local computing device stores the control parameters (nrotₕₘ, dirₕₘ and θₕₘ) in its buffer. For brevity, the control parameters (nrotₕₘ, dirₕₘ and θₕₘ) for a given Horizontal Movement Motor will be collectively referred to henceforth as a Horizontal Movement Control Parameter Tuple Tₕₘ=(nrotₕₘ, dirₕₘ, θₕₘ).

In an embodiment of the present disclosure, synchronisation of movements of all Horizontal Movement Motors is achieved through their connection through a real-time synchronization interface 118 such as, for example, with use of an EtherCAT microchip to allow the carrier device 105 to be moved at a pre-defined speed ξ (e.g. ξ=0.1 m/s). The pre-defined speed and direction of travel computed by the control unit 114 for the robotic device 106 may take into account a balance, for instance, a trade-off between one or more imperatives including, but not limited to, reducing travel time considering the constraints imposed by the physical limitations of the aerial module 101 or executing smooth starting and stopping of the robotic device 106 whilst ensuring safe movement of the robotic device 106 within the Aerial Movement Volume 110 of the aerial module 101.

For sake of simplicity in this disclosure, referring to FIG. 1, the carrier device 105 is shown adapted to move within the bounded horizontal plane 112. The movement of the carrier device 112 is achieved by varying the length i.e., through the lengthening or shortening of at least two horizontal wires 102 from the set of horizontal wires 102 that connect the carrier device 112 to the elevated anchor points 104. Thus, referring to FIGS. 2 and 3, the carrier device 105 is shown to move in either, or both, the x and y directions of the CDRS. Moreover, as each local computing device is synchronized through the shared real-time synchronization interface 118 of the control unit 110 to ensure simultaneous yet independent control and operation of the respective Horizontal Movement Motors, it is to be understood that the set of horizontal wires 102 moveably connecting each anchor point 104 to the carrier device 105 is maintained taut by mutually optimized speeds, directions and numbers of rotation executed by corresponding ones of the Horizontal Movement Motors via the computed parameters (nrotᵢ, dirᵢ and θᵢ). However, it is hereby contemplated that in alternative embodiments of the present disclosure, the set of horizontal wires 102 may not be taut, rather, the carrier device 105 may be partially suspended in relation to the horizontal plane 112 using pre-computed slack willfully, or deliberately, imparted to one or more of the horizontal wires 102, as computed by the control unit 114 depending upon specific requirements of an application.

With further execution of the navigation algorithm, the system's movements are expanded from the horizontal plane 112 to the Aerial Movement Volume 110. Specifically the robotic device 106 is lowered/raised from its current elevation (i.e. the elevation of the start point A) to the elevation of the endpoint B. This is achieved using the Vertical Movement Motor(s) which controls the vertical wire 107 that links the carrier device 105 and the robotic device 106. The control parameters (nrotᵥₘ, dirᵥₘ, and θᵥₘ) for the Vertical Movement Motor(s) are determined using the equations below.

$$\begin{matrix}n r o {t}_{v m} = \frac{\vert {l}_{4 A} - {l}_{4 B} \vert}{k} & ( 19 ) \\ di {r}_{v m} = sign ( {l}_{4 A} - {l}_{4 B} ) & ( 20 ) \\ {θ}_{v m} = \frac{n r o {t}_{v m}}{{t}_{nav}} & ( 21 )\end{matrix}$$

For brevity, the control parameters nrotᵥₘ, dirᵥₘ and θᵥₘ) or each Vertical Movement Motor will be collectively referred to henceforth as a Vertical Movement Control Parameter Tuple Tᵥₘ=(nrotᵥₘ, dirᵥₘ, θᵥₘ).

The same tₙₐᵥ is used for both the movements of the carrier device 105 and the robotic device 106 to synchronize the Horizontal Movement Motors and the Vertical Movement Motor(s), and therefore, to move the robotic device 106 along the AB line segment.

The previous discussion has focused on movement within the Aerial Movement Volume 110 from a known start point A to a known end point B. The following discussion builds on this, to describe methods of determining successive points along a movement trajectory from a start point S to a destination point D wherein the movement trajectory enables avoidance of intervening obstacles between point S and point D. Having determined these successive points, the method described above is used to move the robotic device 106 between successive points along the movement trajectory until the robotic device 106 reaches the destination point D.

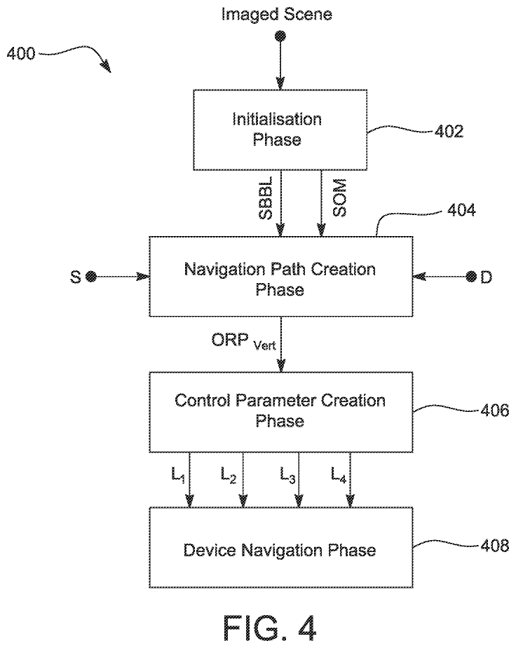

FIG. 4 illustrates a method for navigating the aerial robotic device within an aerial movement volume of the aerial module, in accordance with an embodiment of the present disclosure.

As shown, at step 402, the method 400 includes the performing of an Initialisation Phase. The Initialisation Phase 402 builds a map of obstacles in the Aerial Movement Volume 110. The Initialisation Phase 402 is executed at system installation time, and repeated periodically to address changes in the surveyed environment.

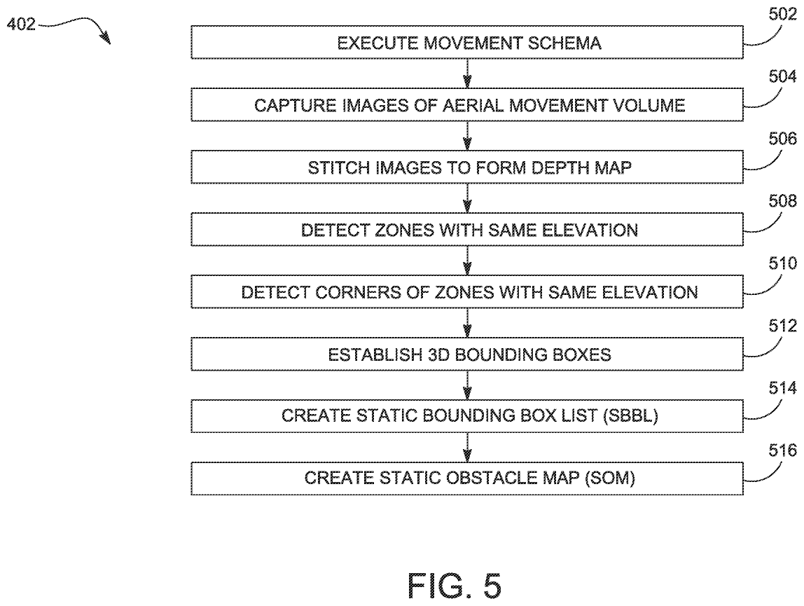

FIG. 5 illustrates the steps of an Initialisation Phase of the method of FIG. 4, in accordance with an embodiment of the present disclosure.

As shown, at step 502, the Initialisation Phase 402 of the method 400 includes the carrier device 105 performing reconnaissance of the Aerial Movement Volume 110 by executing a pre-defined movement schema in the horizontal plane (112 in FIG. 1 or CDRS in FIG. 3) to detect the presence of objects in the Aerial Movement Volume 110. In the event the horizontal plane (112 in FIG. 1 or CDRS in FIG. 3) has a greater elevation than the tops of any obstacles in the Aerial Movement Volume 110, the carrier device 105 can move freely in the horizontal plane (112 in FIG. 1 or CDRS in FIG. 3) without risk of collision with the obstacles. Furthermore, the depth-detecting sensor 116 mounted on the carrier device 105 is provided with a substantially unobscured view of obstacles beneath it in the Aerial Movement Volume 110.

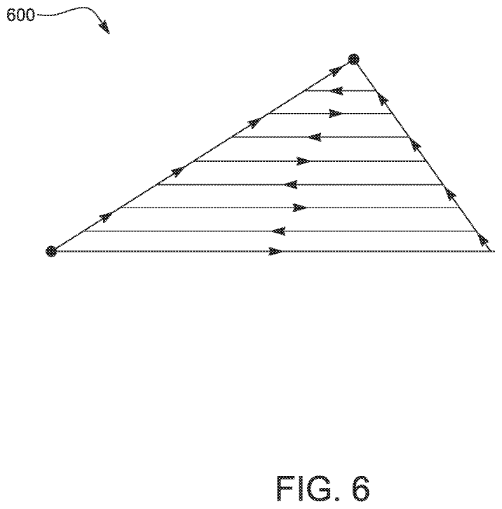

FIG. 6 illustrates an example of a movement schema to be executed by the carrier device 105 during the Initialisation Phase of FIG. 5 in accordance with an embodiment of the present disclosure.

As shown, in this example, the movement schema comprises a looped zig-zag patrol pattern 600. More specifically, the horizontal plane (112 in FIG. 1 or CDRS in FIG. 3) is divided into a plurality of looped patrol paths arranged in parallel and progressing from the widest to the narrowest region of the horizontal plane (112 in FIG. 1 or CDRS in FIG. 3). The distance between successive looped patrol paths is parametrized by p, the pace. The value of p is chosen so that it does not exceed the aperture of the depth-detecting sensor 116 mounted on the carrier device 105. In this way, there are no gaps between the areas surveyed by successive looped patrol paths.

The skilled person will understand that the looped zig-zag patrol pattern shown in FIG. 6 is provided for illustration purposes only. In particular, the skilled person will understand that the the movement schema to be implemented during the Initialisation Phase of the preferred embodiment is in no way limited to a looped zig-zag patrol pattern. Instead, the Initialisation Phase is operable with any movement schema which enables an efficient patrol of the horizontal plane (112 in FIG. 1 or CDRS in FIG. 3) sufficient to enable a full reconnaissance of the Aerial Movement Volume 110. For example, the movement schema may comprise a grid pattern or an arcuate loop pattern or inwards and outwards spiralling pattern.

Returning to FIG. 5, as the carrier device 105 executes the movement schema, at step 504, the Initialisation Phase 402 of the method 400 further includes the depth-detecting sensor 116 capturing images of the Aerial Movement Volume 110 beneath it. In the embodiment in which the depth-detecting sensor 116 is an RGBD sensor, the resulting RGBD sensor data provides a set of images of dense depth. An image of dense depth is an image that contains information relating to the distance of the surfaces of objects in the viewed scene from a defined viewpoint. The distances are determined from almost all of the points in the digitized representation of the scene captured in the image.

At step 506, the Initialisation Phase 402 of the method 400 further includes applying a stitching algorithm to the images captured by the depth-detecting sensors 116 to construct a panoramic view of the Aerial Movement Volume 110. From this, a map is created of objects detected in the Aerial Movement Volume 110 detailing the distance of each such detected object from the depth-detecting sensor 116 when it is positioned overhead the detected object. For brevity, this map is referred to henceforth as a Depth Map of the Aerial Movement Volume 110.

Since the elevation of the horizontal plane (112 in FIG. 1 or CDRS in FIG. 3) is known, the elevation of the depth-detecting sensor 116 mounted on the carrier device 105 is also known. Thus, the distances of detected objects from the depth-detecting sensor 116 as represented in the Depth Map, may be subtracted from the elevation of the depth-detecting sensor 116 to calculate the elevations of the said objects.

At step 508, the Initialisation Phase 402 of the method 400 further includes applying a segmentation algorithm to the Depth Map to detect zones therein with the same elevation.

At step 510, the Initialisation Phase 402 of the method 400 further includes applying a Hough transform to the borders of the detected zones to detect the corner points thereof.

An Elevated Zone is defined as a zone in the Depth Map whose elevation exceeds a pre-defined tolerance threshold. Thus, the detection of an Elevated Zone in the Depth Map indicates the presence of a potential obstacle to the movement of the robotic device 106 in the Aerial Movement Volume 110.

At step 512, the Initialisation Phase 402 of the method 400 further includes using corner points of one or more adjoining Elevated Zones to establish a 3D bounding box around a corresponding Elevated Zone or a group of adjoining Elevated Zones. For brevity and clarity, a 3D bounding box around an Elevated Zone or a group of adjoining Elevated Zones will be referred to henceforth as an Obstacle Bounding Box.

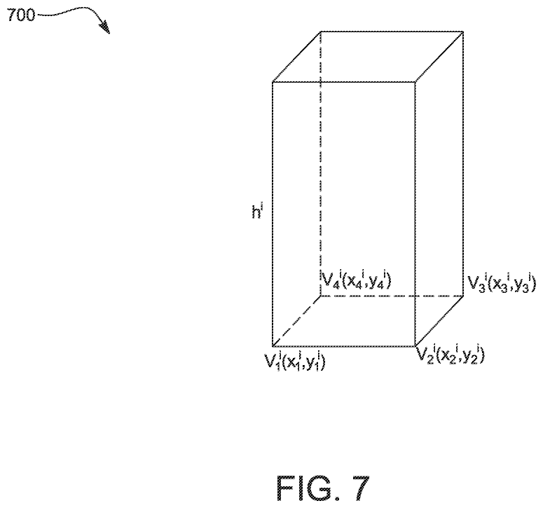

FIG. 7 illustrates a cuboid 700 representing a bounding box, in accordance with an embodiment of the present disclosure. A 3D bounding box is the minimum rectangular cuboid that fully encloses a three-dimensional object. A 3D bounding box i is defined by a set of nine values comprising the x and y co-ordinates of the four vertices of a horizontal rectangular face of the box Vⁱₖ(xₖ, yₖ) k∈{1,2,3,4} and an elevation hⁱ, representing the height of the cuboid.

Returning to FIG. 5, in an embodiment of the present disclosure, as shown, at step 512, the Initialisation Phase 402 of the method 400 further includes using the borders of an Elevated Zone or a group of adjoining Elevated Zones to establish the vertices of a corresponding Obstacle Bounding Box B_{obs}. Furthermore, the elevation of the Elevated Zone or group of adjoining Elevated Zones may be used as the elevation of the Obstacle Bounding Box B_{obs}. Thus, in effect, a Obstacle Bounding Box B_{obs} forms an approximation of the volume of an obstacle detected in the Aerial Movement Volume 110.

Let xᵢ^{obs} and yᵢ^{obs} be the x and y coordinates of a point in an i^{th} Obstacle Bounding Box B_{obs}(i) projected into the horizontal plane (112 in FIG. 1 or CDRS in FIG. 3). For clarity, each such point (xᵢ^{obs}, yᵢ^{obs}) may be referred to henceforth as an Occupied Point. Further, z_{obs}(i) is defined as the elevation of the Occupied Point. Thus, an i^{th} Obstacle Bounding Box B_{obs}(i) can be represented as the Obstacle Bounding Box Function Bᵢ^{obs}(x, y) where Bᵢ^{obs}(xᵢ^{obs}, yᵢ^{obs})=z_{obs}(i) and Bᵢ^{obs}(x≠x_{obs}(i), y≠y_{obs}(i))=−∞.

At step 514, the Initialisation Phase 402 of the method 400 further includes creating a Static Bounding Box List (SBBL) using the Obstacle Bounding Boxes established in step 512. A Static Bounding Box List (SBBL) is a list of all the Obstacle Bounding Boxes established in the Aerial Movement Volume 110. In other words, defining N_{box} as the number of Obstacle Bounding Boxes established in the Aerial Movement Volume 110, the Static Bounding Box List (SBBL) is given by SBBL={B_{obs}(i)}ᵢ₌₁^{N}^{_{box}}.

At step 516, the Initialisation Phase 402 of the method 400 further includes forming a Static Obstacle Map (SOM) by the union of the Obstacle Bounding Boxes identified in the SBBL. In other words, the Static Obstacle Map (SOM) is given by SOM={B_{obs}(i)∪B_{obs}(j≠i)}_{i=1,j=}^{N}^{_{box}}. Since the x and y coordinates of a point in an i^{th} Obstacle Bounding Box B_{obs}(i) projected into the horizontal plane is an Occupied Point, the Obstacle Bounding Boxes of the Static Obstacle Map (SOM) collectively form Occupied Regions in the Aerial Movement Volume 110.

Returning to FIG. 4, the creation of the Static Bounding Box List (SBBL) and the Static Obstacle Map (SOM) represents the end of the Intialisation Phase 402 of the method 400.

At step 404, the method 400 includes performing a Navigation Path Creation Phase. The purpose of the Navigation Path Creation Phase 404 is to determine an optimal route that allows the robotic device 106 to navigate between any two points in the Aerial Movement Volume 110 while avoiding obstacles detected during the Intialisation Phase 402 and represented in the Static Obstacle Map. The input to the Navigation Path Creation Phase 404 includes a start location S=(x_{S}, y_{S}, z_{S}) of the robotic device 106 within the Aerial Movement Volume 110, the required destination location D=(x_{D}, y_{D}, z_{D}), the Static Bounding Box List (SBBL) and the Static Obstacle Map (SOM) determined during the Initialisation Phase 402.

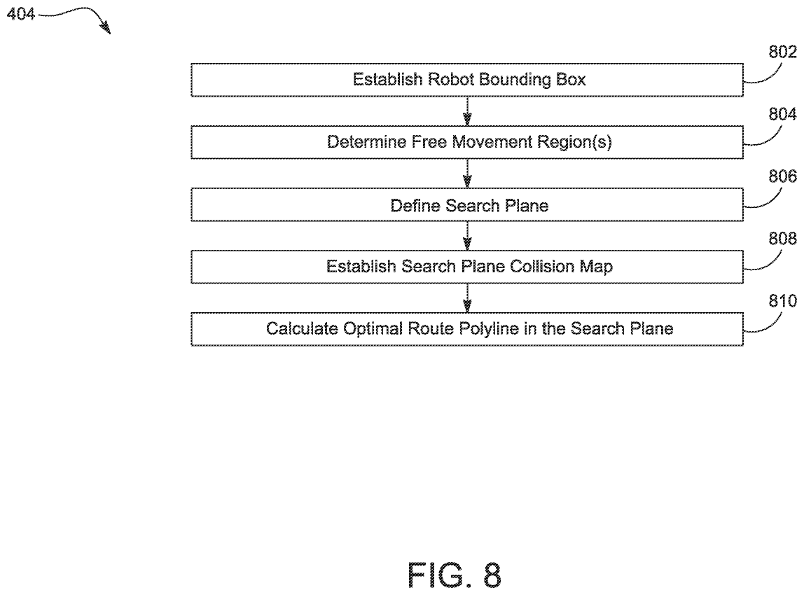

FIG. 8 illustrates the steps of a Navigation Path Creation Phase 404 of the method of FIG. 4, in accordance with an embodiment of the present disclosure

At step 802, the Navigation Path Creation Phase 404 of the method 400 includes establishing a Robot Bounding Box B_{rob} using a convex approximation of the space occupied by the robotic device 106 and an added pre-defined safety tolerance volume around the robotic device 106. The Robot Bounding Box B_{rob} is dimensioned to fully enclose the robotic device 106 and the safety tolerance volume. By centering the robotic device 106 in the Robot Bounding Box B_{rob}, the x and y co-ordinates of its vertices can be defined as ±x^{rob} and ±y^{rob}. Thus, the Robot Bounding Box B_{rob} may be represented as the Robot Bounding Box Function B^{rob}(x, y) where B^{rob} (−x^{rob}<x<x^{rob}, −y^{rob}<y<y^{rob})=z^{rob} and B^{rob}(|x−x^{rob}|<0, |y−y^{rob}|<0)=−∞.

At step 804, the Navigation Path Creation Phase 404 of the method 400 further includes determining one or more Free Movement Regions. A Free Movement Region is a region in the Aerial Movement Volume 110 where the robotic device 106 can move without colliding with a detected obstacle. A Free Movement Region may be determined by computing the grayscale morphological dilation of an Obstacle Bounding Box Function Bᵢ^{obs}(x, y) with the Robot Bounding Box Function B^{rob} (x, y), as follows:

$$f ( {x}_{j} , {y}_{j} ) = {\underbrace{sup}}_{x , y ∈ CDRS} [ {B}_{i}^{o b s} ( {x}_{j} , {y}_{j} ) + {B}^{rob} ( \vert {x}_{j} - {x}^{rob} \vert , \vert {y}_{j} - {y}^{rob} \vert ) ] \qquad ( 22 )$$

In equation (22), sup denotes supremum and (xⱼ,yⱼ) spans the horizontal plane (112 in FIG. 1 or CDRS in FIG. 3). Thus, since each (xⱼ,yⱼ) is a discrete point in the horizontal plane (112 in FIG. 1 or CDRS in FIG. 3), the corresponding Free Movement Regions W_{f} are defined as the set of points satisfying:

(x_{f},y_{f},z_{f})|z_{f}>f(x_{f},y_{f}). (23)

Similarly, Occupied Regions are defined by the points not satisfying equation (23). Since Obstacle Bounding Box Functions Bᵢ^{obs}(x, y) and the Robot Bounding Box Function B^{rob}(x, y) are both defined by cuboids, the resulting Occupied Regions are also a union of cuboids.

Using this formulation, the problem solved during the Navigation Path Creation Phase 404 of the method 400 may be stated as: given the robotic device's current location S=(x_{S},y_{S},z_{S}); a desired destination D=(x_{D},y_{D},z_{D}); and Free Movement Regions W_{f} in the Aerial Movement Volume 110, find an optimal path from S to D, within W_{f}.

At step 806, the Navigation Path Creation Phase 404 of the method 400 further includes defining a Search Plane containing the start location S and destination location D. The Search Plane is defined by an equation of the form:

z=ax+by+c (24)

Using the known coordinates of the start location S in equation (24) produces two equations in unknowns a, b and c:

z_{S}=ax_{S}+by_{S}+c (25)

z_{D}ax_{D}+by_{D}+c (26)

The Search Plane is defined by an additional constraint in which all points in the Search Plane, have a constant elevation on a same line orthogonal to the line S-D. The angle of this line with respect to the x direction is given by:

cos(α)=(y_{D}−y_{S})/\sqrt{(x_{D}−x_{S})²+(y_{D}−y_{S})²} (27)

Displacing point A with a unit step on the plane z=z_{A} in a direction perpendicular to the line S-D, leads to a point A′ with coordinates

x_{A′}=x_{A}+cos α (28)

y_{A′}=y_{A}+sin α (29)

z_{A′}=z_{A} (30)

This supports the third equation needed to find the coefficients defining the Search Plane

z_{A}=ax_{A′}+by_{A′}+c (31)

In step 808, the Navigation Path Creation Phase 404 of the method 400 further includes establishing a Search Plane Collision Map. A first step to establishing the Search Plane Collision Map comprises selecting from the vertices of each Obstacle Bounding Box listed in the Static Bounding Box List, those that are located above the Search Plane. Thus, the selected vertices Vₛⁱ are given by:

Vₛⁱ={(xₖⁱ,yₖⁱ,hⁱ)|hⁱ≥axₖⁱ+byₖⁱ+c},k=1,2,3,4 (32)

Depending on the shape of an obstacle whose Obstacle Bounding Box is listed in the Static Bounding Box List; it can have 0 to 4 vertices located above the Search Plane. If an Obstacle Bounding Box B^{obs}(i) has at least two such vertices, a 2D Collision Bounding Box CB(i) is defined for the Obstacle Bounding Box B^{obs}(i). The Collision Bounding Box CB(i) is defined by those vertices located above the Search Plane of maximum and minimum valued x and y co-ordinates (x_{s_min}ⁱ, y_{s_min}ⁱ) and (x_{s_max}ⁱ, y_{s_max}ⁱ).

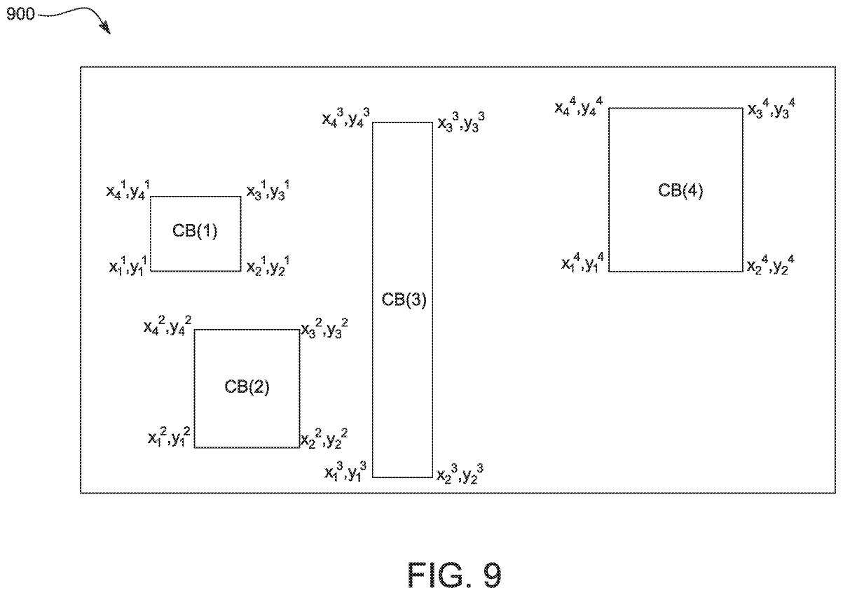

The Search Plane Collision Map is formed by the union of the Collision Bounding Boxes, CB(i). An example of a Search Plane Collision Map 900 is given with reference to FIG. 9.

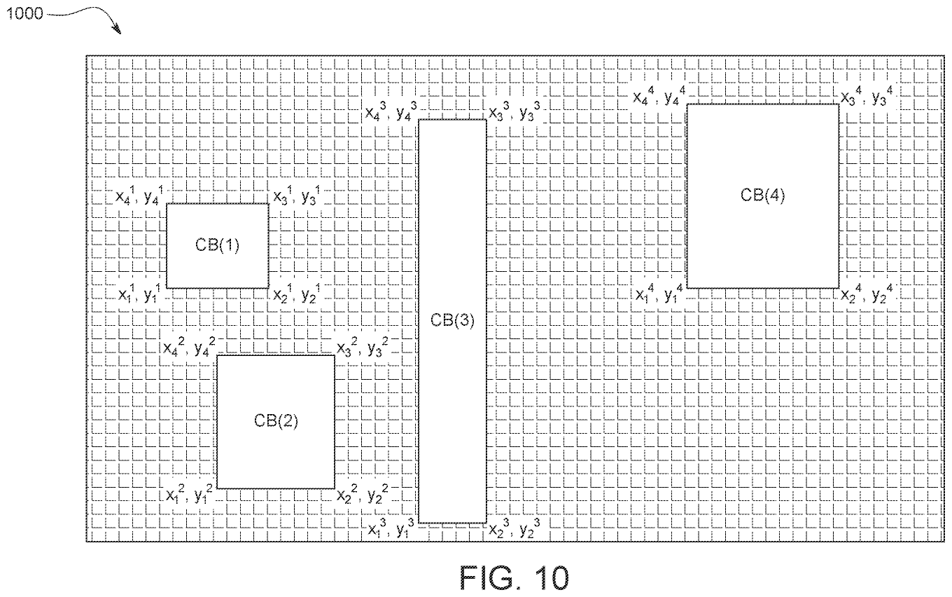

FIG. 10 illustrates a uniform 2D grid 1000 created from the Search Plane Collision Map 900 shown in FIG. 9, in accordance with an embodiment of the present disclosure. The spacing between individual grid lines d_{grid}, equals the length of the diagonal across the horizontal face of the Robot Bounding Box B_{rob}. The vertices of the Collision Bounding Boxes CB(i) are also defined within the 2D grid.

Returning to FIG. 8, in step 810, the Navigation Path Creation Phase 404 of the method 400 further includes calculating an Optimal Route Polyline. The Optimal Route Polyline is the shortest length 3D polyline that connects the projections of the start and destination locations S and D in the Search Plane and avoids intervening Collision Bounding Boxes CB(i).

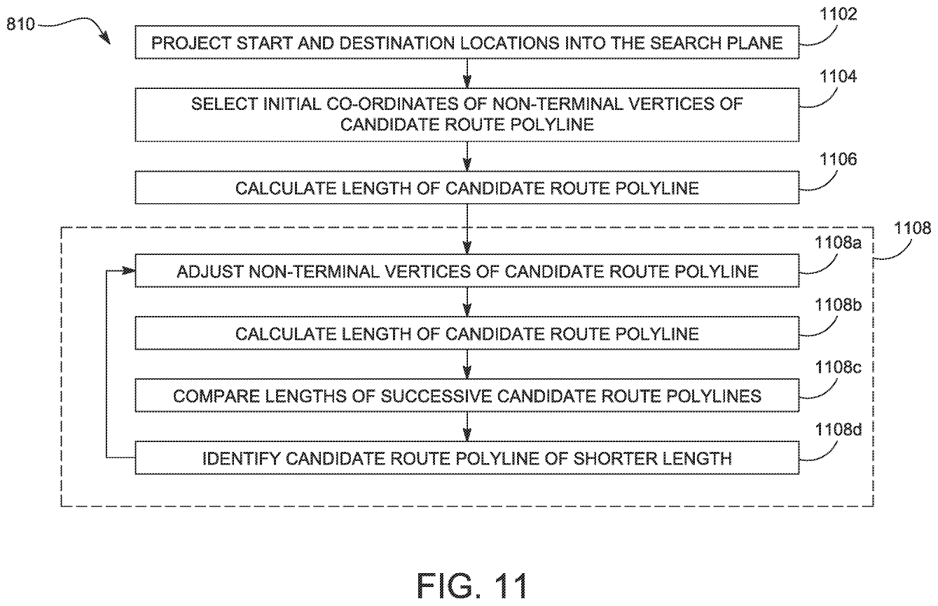

FIG. 11 illustrates the steps of a calculate Optimal Route Polyline step of the Navigation Path Creation Phase of FIG. 8, in accordance with an embodiment of the present disclosure.

In step 1102, the Optimal Route Polyline step 810 of the Navigation Path Creation Phase 404 of the method 400 includes projecting the start and destination locations S and D into the Search Plane, to produce S* (xₛ,y_{S},zₘₐₓ) and D* (x_{D},y_{D},zₘₐₓ).

The route between S* and D* which avoids Collision Bounding Boxes CB(i) is formed from a 3D polyline. A 3D polyline is a connected sequence of straight-line segments created as a single object in a three dimensional space. The object is specified by the endpoints of each of its line segments; and the endpoint of each line segment is known as a vertex of the polyline. For the sake of brevity, the 3D polyline connecting S* and D* which avoids collision bounding boxes CB(i), may be referred to henceforth as the Candidate Route Polyline (CRP). In a Candidate Route Polyline (CRP) comprising k line segments, individual line segments may be denoted by CRP_{Seg(i)} where i=1 to k; and the Candidate Route Polyline's vertices may be denoted by CRP_{Vert(j)} where j=1 to k+1. Thus, CRP_{Vert(1)} and CRP_{Vert(2)} may be the endpoints of CRP_{Seg(1)}; CRP_{Vert(2)} and CRP_{Vert(3)} may be the endpoints of CRP_{Seg(2)}, and so on, until CRP_{Vert(k)} and CRP_{Vert(k+1)} which will be the endpoints of CRP_{Seg(k)}. For brevity, CRP_{Vert(1)} and CRP_{Vert(k+1)} will be referred to henceforth as the First Terminal Vertex and the Second Terminal Vertex respectively. Similarly, the remaining vertices CRP_{Vert(j)} where j=2 to k will be referred to henceforth as the Non-Terminal Vertices.

Since the Candidate Route Polyline (CRP) connects S* and D*, the co-ordinates of the First Terminal Vertex will be S* and the co-ordinates of the Second Terminal Vertex will be D*. The co-ordinates of the First Terminal Vertex and the Second Terminal Vertex remain fixed during the calculate Optimal Route Polyline step 810 of the Navigation Path Creation Phase 404 of the method 400. However, the co-ordinates of the Non-Terminal Vertices are varied during the Optimal Route Polyline step 810 to enable the Optimal Route Polyline to be determined.

In step 1104, the Optimal Route Polyline step 810 of the Navigation Path Creation Phase 404 of the method 400 further includes selecting initial positions of the Non-Terminal Vertices of a Candidate Route Polyline (CRP).

In step 1106, the Optimal Route Polyline step 810 of the Navigation Path Creation Phase 404 of the method 400 further includes calculating the length of the Candidate Route Polyline (CRP).

In step 1108, the Optimal Route Polyline step 810 of the Navigation Path Creation Phase 404 of the method 400 further includes using an optimisation algorithm to iteratively:
adjust 1108a the Non-Terminal Vertices of the Candidate Route Polyline (CRP);
calculate 1108b the length of the Candidate Route Polyline (CRP);
compare 1108c the lengths of successive Candidate Route Polyline (CRP) from each iteration of the optimisation algorithm; and
identify 1108d from the comparisons the Candidate Route Polyline (CRP) with the shorter length.

The step 1108 of using the optimisation algorithm is continued until no further reduction in the length of the Candidate Route Polyline (CRP) is achieved. In the present embodiment, the optimisation algorithm used in the step 1108 is the rapidly exploring random tree (RRT) algorithm. However, the skilled person will understand that this path planning algorithm is provided for illustration purposes only. In particular, the skilled person will understand that the preferred embodiment is not limited to the use of the rapidly exploring random tree (RRT) algorithm. Instead, the preferred embodiment is operable with any suitable path planning algorithm such as the A* graph traversal algorithm, the D* incremental search algorithm and the Probablistic Roadmap Planner. The result of the optimisation process is the Candidate Route Polyline (CRP) with the shortest length. Thus, this Candidate Route Polyline (CRP) is the Optimal Route Polyline (ORP).

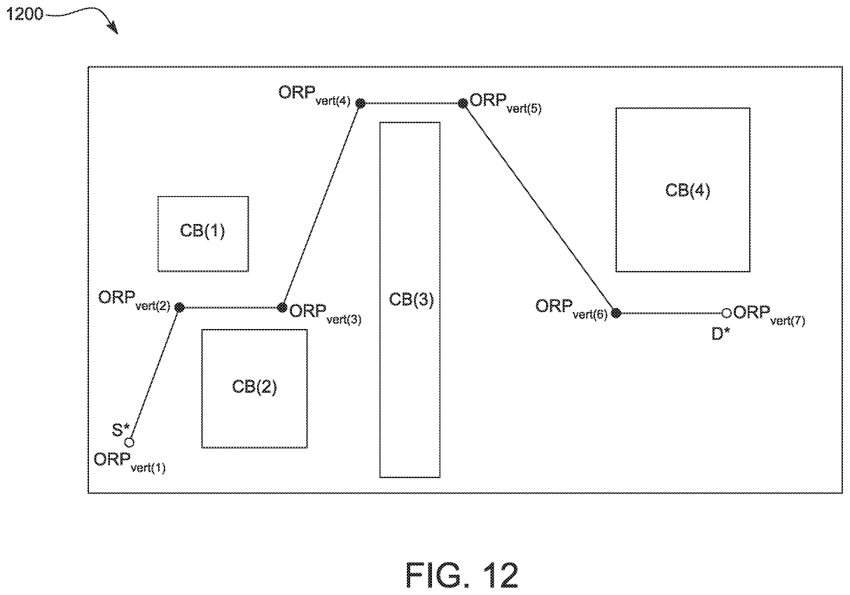

FIG. 12 illustrates an Optimal Route Polyline (ORP) in a Search Plane or a corresponding Search Plane Collision Map 900 of FIG. 9, in accordance with an embodiment of the present disclosure.

The Optimal Route Polyline (ORP) comprises k line segments wherein individual line segments may be denoted by ORP_{Seg(i)} where i=1 to k. The Optimal Route Polyline's vertices may be denoted by ORP_{Vert(j)} where j=1 to k+1. Furthermore, ORP_{Vert(1)}=S* and ORP_{Vert(k+1)}=D*. Thus, ORP_{Vert(1)} and ORP_{Vert(2)} may be the endpoints of ORP_{Seg(1)}; ORP_{Vert(2)} and ORP_{Vert(3)} may be the endpoints of ORP_{Seg(2)}, and so on, until ORP_{Vert(k)} and ORP_{Vert(k+1)} which will be the endpoints of ORP_{Seg(k)}.

With combined reference to FIG. 4, FIG. 8 and FIG. 11, the output of the Navigation Path Creation Phase 404 is the vertices of the Optimal Route Polyline (ORP), ORP_{Vert(j)} where j=1 to k+1.

Returning to FIG. 4, at step 406, the method 400 includes performing a Control Parameter Creation Phase. The Control Parameter Creation Phase 406 creates a set of control parameters to be used by the controllers of the Horizontal Movement Motors and the Vertical Movement Motor(s) to execute the optimal route represented by the vertices of the Optimal Route Polyline (ORP). Specifically, using equations (4)-(6), (11)-(13) and (16)-(18), each of the line segments between the vertices of the Optimal Route Polyline (ORP) are converted into Horizontal Movement Control Parameter Tuples for the controllers of the Horizontal Movement Motors. Similarly, using equations (10), (14) and (19)-(21), each of the line segments between the vertices of the Optimal Route Polyline (ORP) are converted into Vertical Movement Control Parameter Tuple(s) for the controller(s) of the Vertical Movement Motor(s).

Therefore, the output from the Control Parameter Creation Phase 406 comprises at least four Controller Lists L₁, L₂, L₃ and L₄ wherein the each of the first, second and third Controller Lists L₁, L₂, L₃ comprises the Horizontal Movement Control Parameter Tuples Tₕₘ(i) where i=1 to k. Similarly, the fourth and further Controller Lists L₄ comprises the Vertical Movement Control Parameter Tuples Tᵥₘ(i) where i=1 to k. In other words, the number of Horizontal Movement Control Parameter Tuples or Vertical Movement Control Parameter Tuple(s) in each Controller List equals the number of segments (k) in the Optimal Route Polyline (ORP). Thus, the output from the Control Parameter Creation Phase 406 is L₁∈ [symbol] ^{3×k}, L₂∈ [symbol] ^{3×k}, L₃∈ [symbol] ^{3×k} and L₄∈ [symbol] ^{3×k}. Each controller list L₁, L₂, L₃ and L₄ is written to a memory buffer in the controller corresponding with the relevant controller list.

At step 408, the method 400 includes performing a Device Navigation Phase. During the Device Navigation Phase 408, the controllers of the Horizontal Movement Motors and the Vertical Movement Motor(s) are operated in synchrony. Thus, corresponding Horizontal Movement Control Parameter Tuples and Vertical Movement Control Parameter Tuple(s) from each controller list (e.g. Tₕₘ(i), Tₕₘ(i), Tₕₘ(i) and Tᵥₘ(i) where i=1 to k) are executed in parallel by each controller. Executing the Horizontal Movement Control Parameter Tuples and Vertical Movement Control Parameter Tuple(s) associated with a given line segment ORP_{Seg}(i) of the Optimal Route Polyline (ORP), the controllers cause the robotic device 106 to execute a uniform linear movement along the line segment ORP_{Seg}(i). At the end of the line segment ORP_{Seg}(i), the controllers execute the next Horizontal Movement Control Parameter Tuples and Vertical Movement Control Parameter Tuple(s) from their respective controller lists to cause the robotic device 106 to move along the next line segment ORP_{Seg}(i+1) of the Optimal Route Polyline (ORP). This process is continued until the robotic device 106 reaches the required destination D.

It is hereby contemplated that functions consistent with the present disclosure can be embodied as one or more computer-executable software instructions or code that may be stored on a non-transitory computer readable medium. It should be noted that the control unit 114 of the present disclosure may also include one or more processors, micro-processors, controllers, micro-controllers, actuators and the like to individually, or collectively, control operation of the various electric motors in a manner consistent with the present disclosure. These processors, micro-processors, controllers, micro-controllers, actuators and the like may be readily embodied in the form of general purpose computers or application specific controllers that can be readily implemented for use in facilitating operation of the control unit 114 disclosed herein. These software instructions when executed by a processor of the control unit 114 can cause the processor to perform the steps of the methods shown in respective ones of the FIGS. 4-5, 8 and 11 respectively.

In an embodiment of the present disclosure, equipped with this formulation, a closed loop control system (including for example, model-based predictive control mechanisms) may be implemented to adapt the movement parameters in real time to conform with curvilinear kinematics. Such adaptation would allow the robotic device 106 to autonomously implement 3D curvilinear trajectories including spiral, conchoid, helical and hemispherical flight paths. Furthermore, the above formulation supports adaptive control of velocity during different stages of the curvilinear trajectory, such that the robotic device 106 accelerates/decelerates to different velocities at different stages of the curvilinear trajectory. These features would enable the aerial module 101 to be implemented for use in enhanced autonomous reconnaissance and surveillance applications. Example use cases may include, but are not limited to, detailed sweep-in views of a surveyed scene, adaptive top down and side-ways views of stacked or tall items (for example, pallets in a warehouse facility), or items partially obscured by one or more obstacles, and tracking of subjects moving in a curvilinear path.

Modifications to embodiments of the present disclosure described in the foregoing are possible without departing from the scope of the present disclosure as defined by the accompanying claims. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

1. An aerial navigation system comprising:
an aerial robotic device suspended from a vertical wire connected to a carrier device, wherein the carrier device is connected to a plurality of anchor points mounted on corresponding plurality of upright members at a substantially same height from a ground through a set of horizontal wires in a bounded horizontal plane mutually subtended by the plurality of anchor points, and wherein the aerial robotic device is moveable within an aerial movement volume defined between the ground, the plurality of upright members and the horizontal plane; and
a navigation control system for navigating the aerial robotic device in the Aerial Movement Volume, the navigation control system configured to:
detect one or more stationary obstacles located in the Aerial Movement Volume;
create a 3D map representing the Aerial Movement Volume together with one or more bounding boxes enclosing each stationary obstacle in the Aerial Movement Volume;
compute an optimal route for the aerial robotic device from a start location to a destination location so as to avoid an intervening stationary obstacle;
determine control parameters for a plurality of electric stepper motors driving the carrier device and the aerial robotic device based on the computed optimal route for the aerial robotic device, and
navigate the aerial robotic device in accordance with the computed optimal route to enable the aerial robotic device to reach the destination location while avoiding intervening stationary obstacles.

2. The aerial navigation system of claim 1, wherein the navigation control system comprises:
a depth-detecting sensor provided on the carrier device, the depth-detecting sensor configured to capture images of the Aerial Movement Volume; and
a real-time synchronisation interface for synchronizing movements of the plurality of stepper motors driving the carrier device and the aerial robotic device respectively based on respective control parameters.

3. The aerial navigation system of claim 2, wherein the navigation control system is further configured to perform an initialization phase during which the navigation control system detects one or more stationary obstacles in the Aerial Movement Volume and creates the 3D map of the one or more stationary obstacles in the Aerial Movement Volume by permitting the depth-detecting sensor to perform reconnaissance of the Aerial Movement Volume in accordance with a patrol pattern of a pre-defined movement schema during which the depth-detecting sensor executes movement in the horizontal plane to detect a distance to the detected one or more stationary obstacles present in the Aerial Movement Volume.

4. The aerial navigation system of claim 3, wherein the navigation control system is further configured to:
apply a stitching algorithm to the images captured by the depth-detecting sensor and construct a panoramic view of the Aerial Movement Volume for creating a Depth Map of the Aerial Movement Volume;
apply a segmentation algorithm to the Depth Map to detect zones in the Aerial Movement Volume having similar elevation;
apply a Hough transform to borders of the detected zones for detecting corner points of the detected zones;
establish a 3D bounding box for each of the one or more stationary obstacles using the detected corner points of one or more adjoining Elevated Zones, wherein borders of the one or more adjoining Elevated Zones are used to establish vertices of a corresponding Obstacle Bounding Box, and wherein elevation of the one or more adjoining Elevated Zones are used to establish an elevation of the Obstacle Bounding Box;
create a Static Bounding Box List (SBBL) including a list of the Obstacle Bounding Boxes established for corresponding ones of the one or more stationary obstacles detected in the Aerial Movement Volume; and
create a Static Obstacle Map (SOM) from, or using, a union of the Obstacle Bounding Boxes identified in the SBBL.

5. The aerial navigation system of claim 4, wherein the navigation control system is further configured to perform a navigation path creation phase subsequent to the initialisation phase, provided with the start location, the destination location, the Static Bounding Box List (SBBL) and the Static Obstacle Map (SOM) determined during the Initialisation phase in a navigation path creation phase to determine the optimal route that enables the aerial robotic device to navigate between the start location and the destination location while avoiding obstacles detected represented in the Static Obstacle Map.

6. The aerial navigation system of claim 5, wherein during the navigation path creation phase, the navigation control system is configured to:
establish a Robot Bounding Box using a convex approximation of space occupied by the aerial robotic device and an added pre-defined safety tolerance volume around the aerial robotic device defined by a Robot Bounding Box Function;
determine one or more Free Movement Regions in the 3D map corresponding to the Aerial Movement Volume by computing a grayscale morphological dilation of an Obstacle Bounding Box Function with the Robot Bounding Box Function, each defining one or more occupied regions in the Aerial Movement Volume;
determine a search plane containing the start location and the destination location such that the search plane has a substantially constant elevation orthogonal to each of the start location and the destination location to define a 2D Collision Bounding Box for each Obstacle Bounding Box;
form a Search Plane Collision Map from a union of Collision Bounding Boxes corresponding to the one or more stationary obstacles detected in the Aerial Movement Volume; and
calculate an Optimal Route Polyline representative of a shortest length 3D polyline that connects projections of the start and destination locations in the Search Plane and avoids intervening 2D Collision Bounding Boxes.

7. The aerial navigation system of claim 6, wherein the navigation control system is configured to calculate the Optimal Route Polyline by:
projecting the start and destination locations into the Search Plane and use the projections to form a Candidate Route Polyline (CRP) that avoids the intervening 2D collision bounding boxes,
selecting initial positions of one or more Non-Terminal Vertices of the CRP;
calculate a length of the CRP;
use an optimisation algorithm to iteratively:
adjust the one or more Non-Terminal Vertices of the CRP,
calculate the length of the CRP;
compare lengths of successive CRPs obtained from each iteration of the optimisation algorithm; and
identify from the comparisons the CRP with the shorter length.

8. The aerial navigation system of claim 7, wherein the navigation control system is configured to use the optimisation algorithm until the CRP of shortest possible length is achieved.

9. The aerial navigation system of claim 8, wherein the optimisation algorithm includes at least one of a rapidly exploring random tree (RRT) algorithm, a graph traversal algorithm, a incremental search algorithm and a Probablistic Roadmap Planner.

10. A method for navigating an aerial robotic device suspended from a vertical wire connected to a carrier device, and wherein the carrier device to is connected to a plurality of anchor points mounted on corresponding plurality of upright members at a substantially same height from a ground through a set of horizontal wires in a bounded horizontal plane mutually subtended by the plurality of anchor points, and wherein the aerial robotic device is moveable within an aerial movement volume defined between the ground, the plurality of upright members and the horizontal plane, the method comprising:
detecting one or more stationary obstacles located in the Aerial Movement Volume;
creating a 3D map representing the Aerial Movement Volume together with one or more bounding boxes enclosing each stationary obstacle in the Aerial Movement Volume;
computing an optimal route for the aerial robotic device from a start location to a destination location so as to avoid an intervening stationary obstacle;
determining control parameters for a plurality of electric stepper motors driving the carrier device and the aerial robotic device respectively, based on the computed optimal route for the aerial robotic device; and
navigating the aerial robotic device in accordance with the computed optimal route to enable the aerial robotic device to reach the destination location while avoiding intervening stationary obstacles.

11. The method of claim 10 further comprising:
providing a depth-detecting sensor on the carrier device, the depth-detecting sensor configured to capture images of the Aerial Movement Volume; and
providing a real-time synchronisation interface on a navigation control unit in communication with the plurality of electric stepper motors for synchronizing movements of stepper motors driving the carrier device and the aerial robotic device respectively based on the control parameters determined for each of stepper motors driving the carrier device and the aerial robotic device respectively.

12. The method of claim 11 further comprising detecting one or more stationary obstacles in the Aerial Movement Volume and creating the 3D map of the one or more stationary obstacles detected in the Aerial Movement Volume by permitting the depth-detecting sensor to perform reconnaissance of the Aerial Movement Volume in accordance with a patrol pattern of a pre-defined movement schema during which the depth-detecting sensor executes movement in the horizontal plane to detect a distance from itself to the detected one or more stationary obstacles present in the Aerial Movement Volume.

13. The method of claim 12 further comprising:
applying a stitching algorithm to the images captured by the depth-detecting sensor and construct a panoramic view of the Aerial Movement Volume for creating a Depth Map of the Aerial Movement Volume;
applying a segmentation algorithm to the Depth Map to detect zones in the Aerial Movement Volume having similar elevation;
applying a Hough transform to borders of the detected zones for detecting corner points of the detected zones;
establishing a 3D bounding box for each of the one or more stationary obstacles using the detected corner points of one or more adjoining Elevated Zones, wherein borders of the one or more adjoining Elevated Zones are used to establish vertices of a corresponding Obstacle Bounding Box, and wherein elevation of the one or more adjoining Elevated Zones are used to establish an elevation of the Obstacle Bounding Box;
creating a Static Bounding Box List (SBBL) using the Obstacle Bounding Boxes, wherein the Static Bounding Box List (SBBL) is a list of the Obstacle Bounding Boxes established for corresponding ones of the one or more stationary obstacles detected in the Aerial Movement Volume; and
creating a Static Obstacle Map (SOM) from, or using, an union of the Obstacle Bounding Boxes identified in the SBBL.

14. The method of claim 13 further comprising using the start location, the destination location, the Static Bounding Box List (SBBL) and the Static Obstacle Map (SOM) in a navigation path creation phase to determine the optimal route that enables the aerial robotic device to navigate between the start location and the destination location while avoiding obstacles represented in the Static Obstacle Map (SOM).

15. The method of claim 14 further comprising:
establishing a Robot Bounding Box using a convex approximation of space occupied by the aerial robotic device and an added pre-defined safety tolerance volume around the aerial robotic device defined by a Robot Bounding Box Function;
determining one or more Free Movement Regions in the 3D map corresponding to the Aerial Movement Volume by computing a grayscale morphological dilation of an Obstacle Bounding Box Function with the Robot Bounding Box Function, each defining one or more occupied regions in the Aerial Movement Volume;
determining a search plane containing the start location and the destination location such that the search plane has a substantially constant elevation orthogonal to each of the start location and the destination location to define a 2D Collision Bounding Box for each Obstacle Bounding Box;
forming a Search Plane Collision Map from a union of the Collision Bounding Boxes corresponding to the one or more stationary obstacles detected in the Aerial Movement Volume; and
calculating an Optimal Route Polyline representative of a shortest length 3D polyline that connects projections of the start and destination locations in the Search Plane and avoids intervening 2D Collision Bounding Boxes.

16. The method of claim 15, wherein the Optimal Route Polyline is calculated by:
projecting the start and destination locations into the Search Plane and use the projections to form a Candidate Route Polyline (CRP) that avoids the intervening 2D collision bounding boxes,
selecting initial positions of one or more Non-Terminal Vertices of the CRP;
calculating a length of the CRP;
using an optimisation algorithm to iteratively:
adjust the one or more Non-Terminal Vertices of the CRP,
calculate the length of the CRP;
compare lengths of successive CRPs obtained from each iteration of the optimisation algorithm; and
identify from the comparisons the CRP with the shorter length.

17. The method of claim 16 further comprising iteratively using the optimisation algorithm until the CRP of shortest possible length is achieved.

18. The method of claim 17, wherein the optimisation algorithm used includes at least one of a rapidly exploring random tree (RRT) algorithm, a graph traversal algorithm, a incremental search algorithm and a Probablistic Roadmap Planner.

19. A non-transitory computer readable medium having stored thereon computer-executable instructions which, when executed by a processor, causes the processor to operate an aerial navigation system having an aerial robotic device suspended from a vertical wire connected to a carrier device, the carrier device connected to a plurality of anchor points mounted on corresponding plurality of upright members at a substantially same height from a ground through a set of horizontal wires in a bounded horizontal plane mutually subtended by the plurality of anchor points, and wherein the aerial robotic device is moveable within an aerial movement volume defined between the ground, the plurality of upright members and the horizontal plane, wherein the processor is configured to:
detect one or more stationary obstacles located in the Aerial Movement Volume;
create a 3D map representing the Aerial Movement Volume together with one or more bounding boxes enclosing each stationary obstacle in the Aerial Movement Volume;
compute an optimal route for the aerial robotic device using an optimisation algorithm, so that the aerial robotic device reaches a required destination while avoiding an intervening stationary obstacle;
determine control parameters for a plurality of electric stepper motors driving the carrier device and the aerial robotic device based on the computed optimal route for the aerial robotic device; and
navigate the aerial robotic device in accordance with the computed optimal route to enable the aerial robotic device to reach the required destination while avoiding intervening stationary obstacles.
